(19) United States
(12) Patent Application Publication
(10) Pub. No.: US 2012/0167161 A1
(43) Pub. Date: Jun. 28, 2012

(54) APPARATUS AND METHOD FOR CONTROLLING SECURITY CONDITION OF GLOBAL NETWORK

(75) Inventor: Ki Young KIM, Daejeon (KR)

(73) Assignee: ELECTRONICS AND TELECOMMUNICATIONS RESEARCH INSTITUTE, Daejeon (KR)

(21) Appl. No.: 13/295,359

(22) Filed: Nov. 14, 2011

(30) Foreign Application Priority Data
Dec. 23, 2010 (KR) 10-2010-0134108

(51) Int. Cl. G06F 21/00

(52) U.S. Cl. 726/1

(57) ABSTRACT

An apparatus for controlling a security condition of a global network includes: an information collection and blocking agent configured to detect a suspicious malicious code, generate security condition information from the detected malicious code, and block the malicious code based on security policy information; and a global security information analysis and control server configured to generate the security policy information by analyzing the security condition information generated by the information collection and blocking agent and provide the generated security policy information to the information collection and blocking agent to prevent the malicious code from spreading.

### CROSS-REFERENCES TO RELATED APPLICATIONS

The present application claims priority under 35 U.S.C 119(a) to Korean Application No. 10-2010-0134108, filed on December 23, 2010, in the Korean intellectual property Office, which is incorporated herein by reference in its entirety set forth in full.

### BACKGROUND

Exemplary embodiments of the present invention relate to a global network security control technology, and more particularly, to an apparatus and method for controlling a security condition of a global network, which is capable of not only early detecting a malicious code propagated from an attacker connected to a network to prevent the malicious code from spreading over the global network, but also detecting and controlling an attack sign occurring on the global network in real time.

A conventional network security system lures an attack of a cracker by mainly using a honey pot or the like to protect the system from malicious codes or collects logs of the lured attack to deal with an attack in the future.

Recently, the number of large-scale attacks delivered to unspecified individuals has increased, and it is not easy for the existing honey pot model to prevent the spread of malicious codes. Accordingly, a global honey pot system or the like has emerged as a method for early detecting malicious codes. However, the performance of the global honey pot system is limited to such a level that the global honey pot system early collects malicious codes propagated into a network in a global environment and derives a result.

Accordingly, the global honey pot system cannot detect malicious codes through real-time detection of the network security condition immediately after the malicious codes are propagated, cannot prevent the spread of the malicious codes, and cannot provide information such as a prediction warning.

The above-described configuration is a related art for helping an understanding of the present invention, and does not mean a related art which is widely known in the technical field to which the present invention pertains.

### SUMMARY

An embodiment of the present invention relates to an apparatus and method for controlling a security condition of a global network, which is capable of detecting malicious codes in emails, messengers, web servers, social network services (SNS) and so on, preventing a network threat condition from spreading over the global network, analyzing an attack sign based on such information, and performing a prevention function before an attack occurs, the network threat condition including bot formation, botnet construction, C&C server and zombie IP spread, DDos attack and so on.

In one embodiment, an apparatus for controlling a security condition of a global network includes: an information collection and blocking agent configured to detect a suspicious malicious code, generate security condition information from the detected malicious code, and block the malicious code based on security policy information; and a global security information analysis and control server configured to generate the security policy information by analyzing the security condition information generated by the information collection and blocking agent and provide the generated security policy information to the information collection and blocking agent to prevent the malicious code from spreading.

The security condition information may include a suspicious malicious code signature and mapping information between malicious code accuracy and vulnerability.

The security policy information may include a distribution status of malicious codes distributed in the global network, connection analysis information of the distributed malicious codes, and signatures of unknown malicious codes.

The information collection and blocking agent may be installed in an ISP.

The global security information analysis and control server may be installed in the global network.

In another embodiment, a method for controlling a security condition of a global network includes: detecting a suspicious malicious code; generating security condition information having a signature of the detected suspicious malicious code and mapping information between malicious code accuracy and vulnerability; generating security policy information based on the security condition information, wherein the security policy information comprises a distribution status of malicious codes distributed in the global network, connection analysis information of the distributed malicious codes, and signatures of unknown malicious codes; and creating a security configuration of the global network and a zombie IP status based on the security policy information and performing a prediction and warning function based on the connection analysis information of the distributed malicious codes.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram explaining the configuration of an apparatus for controlling a security condition of a global network in accordance with an embodiment of the present invention; and

FIG. 2 is a flow chart explaining a method for controlling a security condition of a global network in accordance with another embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

The drawings are not necessarily to scale and in some instances, proportions may have been exaggerated in order to clearly illustrate features of the embodiments. Furthermore, terms to be described below have been defined by considering functions in embodiments of the present invention, and may be defined differently depending on a user or operator's intention or practice. Therefore, the definitions of such terms are based on the descriptions of the entire present specification.

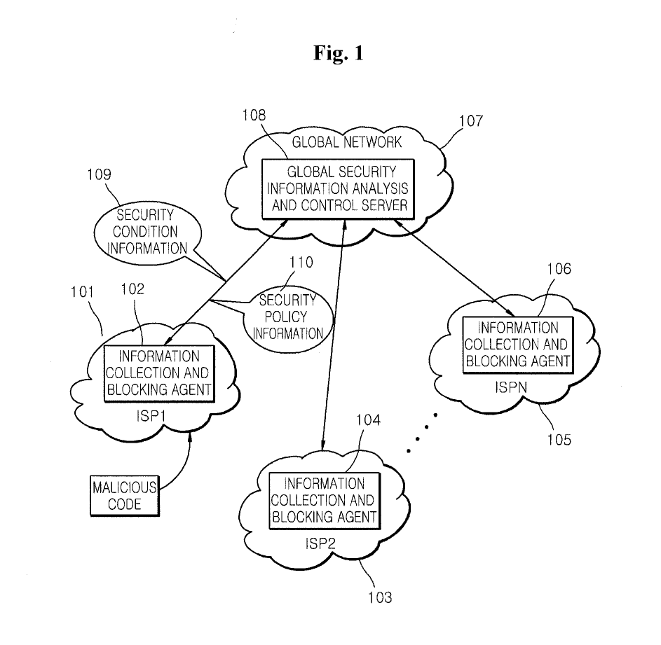

FIG. 1 is a diagram explaining the configuration of an apparatus for controlling a security condition of a global network in accordance with an embodiment of the present invention.

Referring to FIG. 1, the apparatus for controlling a security condition of a global network in accordance with an embodiment of the present invention includes information collection and blocking agents 102, 104, and 106 and a global security information analysis and control server 108.

The information collection and blocking agents 102, 104, and 106 are configured to detect malicious codes at entry points of ISPs 101, 103, and 105 to which the malicious codes are first propagated.

The information collection and blocking agents 102, 104, and 106 transmit security condition information 109 to the global security condition and control server 108 of the global network 107. The security condition information 109 includes suspicious malicious code signatures detected by the respective ISPs 101, 103, and 105 and mapping information between accuracy of the related attack and vulnerability.

The global security condition analysis and control server 108 is configured to analyze an attack condition relation at a nationwide level, create a malicious code distribution status, and analyze an attack sign depending on network configurations such as region, IP, and event, in connection with the malicious code related information 109 which is transmitted from the information collection and blocking agents 102, 104, and 106 and includes the suspicious malicious code signatures detected by the respective ISPs 101, 103, and 105 and the security condition information 109 collected by various network security equipments such as botnet detection equipments and DDos detection and blocking equipments of the respective ISPs.

Furthermore, the global security information analysis and control server 108 transmits global security policy information 110 to the information collection and blocking agents 102, 104, and 106 of the respective ISPs 101, 103, and 105 according to the created malicious code distribution status, early blocks a connection of an attacker at a recent entry point of a malicious code site according to the security policy information 110, and performs an attack prediction warning function through construction of a global security information sharing framework.

In other words, the global security information analysis and control server 108 detects suspicious malicious codes in emails, messengers, web servers, and SNS and prevents a network threat condition caused by the malicious codes from spreading over the global network. The network threat condition may include bot formation, botnet construction, C&C server and zombie IP spread, and a DDos attack.

Furthermore, the global security information analysis and control server 108 analyzes an attack sign based on the security condition information 109 collected by the information collection and blocking agents 102, 104, and 106 and performs a prevention function before an attack occurs.

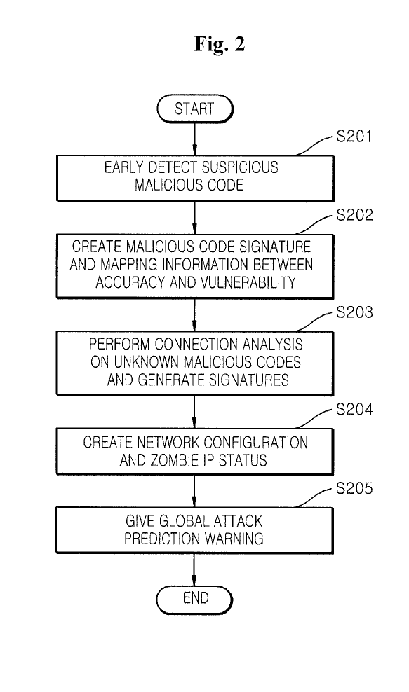

FIG. 2 is a flow chart explaining a method for controlling a security condition of a global network in accordance with another embodiment of the present invention.

Referring to FIG. 2, the information collection and blocking agents 102, 104, and 106 detect malicious codes in the respective

ISPs 101, 103, and 105 to which the malicious codes are propagated, at step S201.

The information collection and blocking agents 102, 104, and 106 create security condition information 109 including the signatures of the suspicious malicious code detected in the respective ISPs 101, 103, and 105 and mapping information between accuracy of the related attack and vulnerability, at step S202.

The information collection and blocking agents 102, 104, and 106 transmit the created security condition information 109 to the global security information analysis and control server 108 of the global network 107.

Then, the global security information analysis and control server 108 receives the security condition information 109 detected in the respective ISPs 101, 103, and 105 from the information collection and blocking agents 102, 104, and 106, performs global-level connection analysis on unknown malicious codes, and generates signatures of the unknown malicious codes, at step S203.

Subsequently, the global security information analysis and control server 108 creates a global network security configuration and a zombie IP status based on the signatures of the malicious codes at step S204, and gives global attack prediction and warning based on the connection analysis status of the distributed malicious codes, at step S205.

As such, the apparatus and method in accordance with the embodiment of the present invention may detect a malicious code in real time to control a network connection, analyze an attackable signature in real time when the malicious code is propagated, generate an accurate malicious code detection signature through the global security condition connection analysis, and provide response technology. Therefore, it is possible to figure out the zombie status of the control network.

Furthermore, it is possible to prevent the spread of unknown malicious codes and attacks of the malicious codes through the global security condition information analysis function.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. An apparatus for controlling a security condition of a global network, comprising:
an information collection and blocking agent configured to detect a suspicious malicious code, generate security condition information from the detected malicious code, and block the malicious code based on security policy information; and
a global security information analysis and control server configured to generate the security policy information by analyzing the security condition information generated by the information collection and blocking agent and to provide the generated security policy information to the information collection and blocking agent to prevent the malicious code from spreading.

2. The apparatus of claim 1, wherein the security condition information comprises a suspicious malicious code signature and mapping information between malicious code accuracy and vulnerability.

3. The apparatus of claim 1, wherein the security policy information comprises a distribution status of malicious codes distributed in the global network, connection analysis information of the distributed malicious codes, and signatures of unknown malicious codes.

4. The apparatus of claim 1, wherein the information collection and blocking agent is installed in an ISP.

5. The apparatus of claim 1, wherein the global security information analysis and control server is installed in the global network.

6. A method for controlling a security condition of a global network, comprising:
detecting a suspicious malicious code;
generating security condition information having a signature of the detected suspicious malicious code and mapping information between malicious code accuracy and vulnerability;
generating security policy information based on the security condition information, wherein the security policy information comprises a distribution status of malicious codes distributed in the global network, connection analysis information of the distributed malicious codes, and signatures of unknown malicious codes; and
creating a security configuration of the global network and a zombie IP status based on the security policy information and performing a prediction and warning function based on the connection analysis information of the distributed malicious codes.
